(19) United States
(12) Patent Application Publication
(10) Pub. No.: US 2026/0237266 A1
(43) Pub. Date: Aug. 13, 2026

(54) DEPOSIT MACHINE

(71) Applicant: GLORY Ltd., Himeji City (JP)

(72) Inventors: Nao Yokoyama, Himeji City (JP); Tetsuya Yamauchi, Himeji City (JP); Shuji Onishi, Himeji City (JP); Hisashi Ishitobi, Himeji City (JP)

(73) Assignee: GLORY Ltd., Himeji City (JP)

(21) Appl. No.: 19/053,328

(22) Filed: Feb. 13, 2025

(51) Int. Cl. G07D 11/00; G07D 11/34; G07D 11/40; G07D 11/60

(52) U.S. Cl. CPC G07D 11/009; G07D 11/34; G07D 11/40; G07D 11/60

(57) ABSTRACT

A deposit machine includes a mounting portion, a display portion and a control portion. The mounting portion is configured to mount a storage container to store coins. The display portion is corresponding to the mounting portion. The control portion is configured to control the display portion to display a first status in response to the storage container mounted on the mounting portion being to a target for removal from the mounting portion. The control portion is configured to control the display portion to display a second status different from the first status in response to the storage container being removed from the mounting portion when the display portion displays the first status.

### BACKGROUND

### Technical Field

The disclosure is related to a deposit machine, and particularly to a coin deposit machine.

### Description of Related Art

In a conventional deposit machine, coin storage pouches are mounted to mounting portions of the deposit machine respectively, and the storage pouch has to be removed from the mounting portion for taking out the coins therein and then the empty storage pouch has to be mounted to the mounting portion again. However, due to the large number of the storage pouches, it is difficult to easily determine which pouches need to be replaced, difficult to remember whether all storage pouches that need to be replaced have been replaced, and it is difficult to conveniently reset the inventory of each the replaced storage pouch and/or remember whether the inventory of each the replaced storage pouch has been reset. Therefore, a user is prone to make mistakes when replacing and resetting the storage pouches of the deposit machine. In addition, in a condition that the storage pouch is a transparent pouch (such as a vinyl pouch) and thus cannot be detected through an optical detection manner, the storage pouch needs to be detected through a contact detection manner. However, it is often unable to be detected successfully through the contact detection manner due to the irregular shape of the soft pouch.

### SUMMARY

A deposit machine of the disclosure includes a mounting portion, a display portion and a control portion. The mounting portion is configured to mount a storage container to store coins. The display portion is corresponding to the mounting portion. The control portion is configured to control the display portion to display a first status in response to the storage container mounted on the mounting portion being a target for removal from the mounting portion, and control the display portion to display a second status different from the first status in response to the storage container being removed from the mounting portion when the display portion displays the first status.

A deposit machine of the disclosure includes a mounting portion, a display portion, a reset button and a control portion. The mounting portion is configured to mount a storage container to store coins. The display portion is corresponding to the mounting portion. The reset button is corresponding to the mounting portion. The control portion is configured to control the display portion to display a first status in response to the storage container mounted on the mounting portion being a target for removal from the mounting portion, and reset an inventory of the storage container in response to the reset button being pressed after the storage container mounted on the mounting portion is removed from the mounting portion and a storage container is mounted on the mounting portion again.

### BRIEF DESCRIPTION OF THE DRAWINGS

FIG. 1 is a perspective view of a deposit machine according to an embodiment of the disclosure

FIG. 2 is a perspective view illustrating a cover of the deposit machine of FIG. 1 being opened.

FIG. 3 is a schematic diagram of partial components of the deposit machine of FIG. 1.

FIG. 4 is a perspective view illustrating a drawer portion of the deposit machine of FIG. 1 being slid out.

FIG. 5 is a perspective view illustrating partial structures of the mounting portion of FIG. 1 mounting a storage container.

FIG. 6 is a perspective view illustrating the partial structures of the mounting portion of FIG. 5.

FIG. 7 is a perspective view illustrating a storage container detection mechanism corresponding to the mounting portion of FIG. 5.

FIG. 8 is a perspective view illustrating the pouch being clamped by the mounting portion of FIG. 7.

FIG. 9 and FIG. 10 are schematic diagrams illustrating an operation manner of the detection portion in FIG. 7 and FIG. 8.

### DESCRIPTION OF THE EMBODIMENTS

The disclosure provides a deposit machine which may prevent a user from making mistakes when replacing and resetting the storage pouches.

A deposit machine of the embodiment includes a mounting portion, a display portion and a control portion. The mounting portion is configured to mount a storage container to store coins. The display portion is corresponding to the mounting portion. The control portion is configured to control the display portion to display a first status in response to the storage container mounted on the mounting portion being a target for removal from the mounting portion, and control the display portion to display a second status different from the first status in response to the storage container being removed from the mounting portion when the display portion displays the first status.

Accordingly, the deposit machine of the embodiment may prevent a user from making mistakes when replacing and resetting the storage containers, so as to shorten the downtime of the deposit machine when replacing and resetting the storage containers. In addition, based on the clear reminder of the display portions of the embodiment, even beginners may replace and reset the storage containers easily.

In an embodiment of the disclosure, the display portion includes an indicating light.

Accordingly, the display portion may clearly display by emitting light.

In an embodiment of the disclosure, the control portion is configured to control the display portion to display a third status different from the second status in response to a storage container being mounted on the mounting portion again.

Accordingly, the deposit machine of the embodiment prevents the user from forgetting to reset the storage container.

In an embodiment of the disclosure, the deposit machine includes a reset button corresponding to the mounting portion. In an embodiment of the disclosure, the reset button is configured to turn off the display portion when pressed after a storage container is mounted on the mounting portion again. In an embodiment of the disclosure, the reset button is configured to reset an inventory of the storage container when pressed after a storage container is mounted on the mounting portion again.

Accordingly, the user may reset the storage container and turn off the display portion at the same time easily by pressing the reset button.

In an embodiment of the disclosure, the display portion is integrated with the reset button.

Accordingly, the arrangement of the display portion and the reset button may be simplified.

In an embodiment of the disclosure, the deposit machine includes a housing having a door, wherein the display portion and the reset button are disposed in the housing, and exposed when the door is opened.

Accordingly, the display portion and the reset button may be hidden by the door to be prevented from being operated accidentally.

In an embodiment of the disclosure, the deposit machine includes a display interface disposed outside the housing, wherein the display interface is configured to display a notification in response to an operation of the deposit machine being resumed without pressing the reset button after the storage container is mounted on the mounting portion again. In an embodiment of the disclosure, an inventory of the storage container is accumulated from a previous amount in response to an operation of the deposit machine being resumed without pressing the reset button even after the storage container is mounted on the mounting portion again.

Accordingly, the user may clearly know whether the storage container has been reset and/or be reminded again if he or she forgot to press the reset button. Moreover, even if a storage container that does not need to be replaced is accidentally removed and reinstalled, the inventory thereof may be accumulated from the previous amount as long as the reset button is not pressed.

In an embodiment of the disclosure, the deposit machine includes a storage container detection mechanism, wherein the mounting portion has a clamp part configured to clamp the storage container, the clamp part has an opening, and the storage container detection mechanism is configured to detect a taut part of the storage container through the opening.

Accordingly, the storage container is detected when it is clamped by the clamp portion to formed the taut part, and the taut part is able to be maintained in a flat state by its tension, such that a situation that the storage container is unable to be detected successfully due to, for example, the irregular shape of the soft storage container may be avoided.

In an embodiment of the disclosure, the mounting portion includes a chute base and a coin chute disposed on the chute base, a side wall of the chute base and a side wall of the coin chute form the clamp part, the mounting portion is configured to clamp the storage container between the side wall of the chute base and the side wall of the coin chute, the opening is formed on the side wall of the chute base, and the storage container detection mechanism is adjacent to the side wall of the chute base and corresponding to the opening.

Accordingly, the storage container may be firmly clamped by the chute base and the coin chute to reliably form the taut part.

In an embodiment of the disclosure, the storage container detection mechanism includes a main body, a detection portion and a movable portion, the detection portion is disposed on the main body, the movable portion is movably disposed on the main body, the movable portion protrudes through the opening toward the mounting portion when the storage container is not clamped by the clamp part, the movable portion is pushed backward from the mounting portion by the storage container when the storage container is clamped by the clamp part, and the detection portion is configured to detect whether the storage container is clamped by the clamp part according to a position of the movable portion relative to the detection portion.

Accordingly, the storage container detection mechanism may accurately detect whether the storage container is mounted on the mounting portion based on the position of the movable portion.

In an embodiment of the disclosure, the detection portion includes an optical detection device. In an embodiment of the disclosure, the optical detection device includes a light emitting element and a light sensing element, the movable portion blocks between the light emitting element and the light sensing element when the movable portion protrudes through the opening toward the mounting portion, and the movable portion is away from between the light emitting element and the light sensing element when the movable portion is pushed backward from the mounting portion.

Accordingly, the storage container detection mechanism may accurately detect whether the storage container is mounted on the mounting portion by the light emitting element and the light sensing element.

In an embodiment of the disclosure, the storage container detection mechanism includes an elastic component, the elastic component is connected between the main body and the movable portion, the movable portion is configured to protrude through the opening toward the mounting portion by an elastic force of the elastic component, and the movable portion is configured to resist the elastic force of the elastic component to be pushed backward from the mounting portion.

Accordingly, the movable portion may restore automatically by the elastic force of the elastic component.

A deposit machine of the disclosure includes a mounting portion, a display portion, a reset button and a control portion. The mounting portion is configured to mount a storage container to store coins. The display portion is corresponding to the mounting portion. The reset button is corresponding to the mounting portion. The control portion is configured to control the display portion to display in response to the storage container mounted on the mounting portion being a target for removal from the mounting portion, and reset an inventory of the storage container in response to the reset button being pressed after the storage container mounted on the mounting portion is removed from the mounting portion and a storage container is mounted on the mounting portion again.

Accordingly, the deposit machine of the embodiment may prevent a user from making mistakes when replacing and resetting the storage containers, so as to shorten the downtime of the deposit machine when replacing and resetting the storage containers. In addition, based on the clear reminder of the display portions of the embodiment, even beginners may replace and reset the storage containers easily.

In an embodiment of the disclosure, the display portion includes an indicating light.

Accordingly, the display portion may clearly display by emitting light.

In an embodiment of the disclosure, the display portion is integrated with the reset button.

Accordingly, the arrangement of the display portion and the reset button may be simplified.

In an embodiment of the disclosure, the deposit machine includes a plurality of the mounting portions, a plurality of the display portions corresponding to the mounting portions respectively and a plurality of the reset buttons corresponding to the mounting portions respectively.

Accordingly, the user may easily replace and reset the plurality of storage containers by the corresponding display portions and reset buttons.

Embodiments of the deposit machine will be described with reference to the drawings. The embodiments of deposit machine described herein are exemplary.

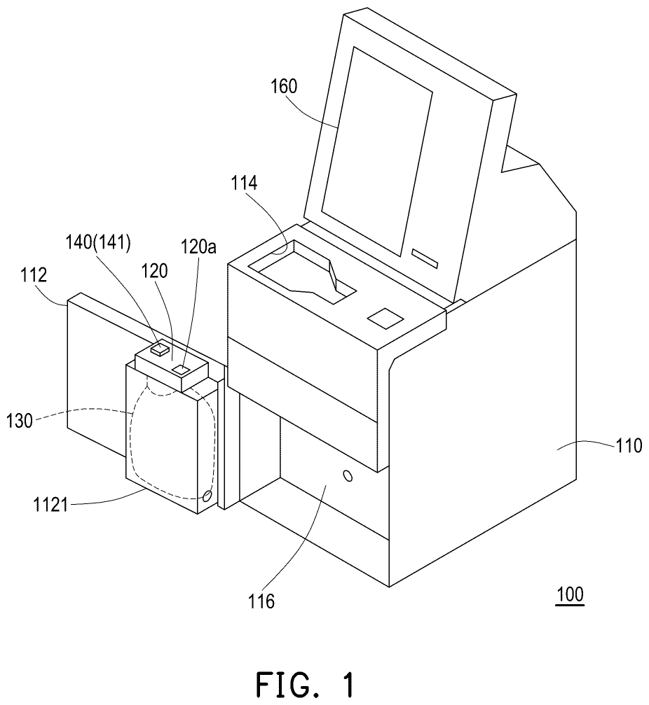

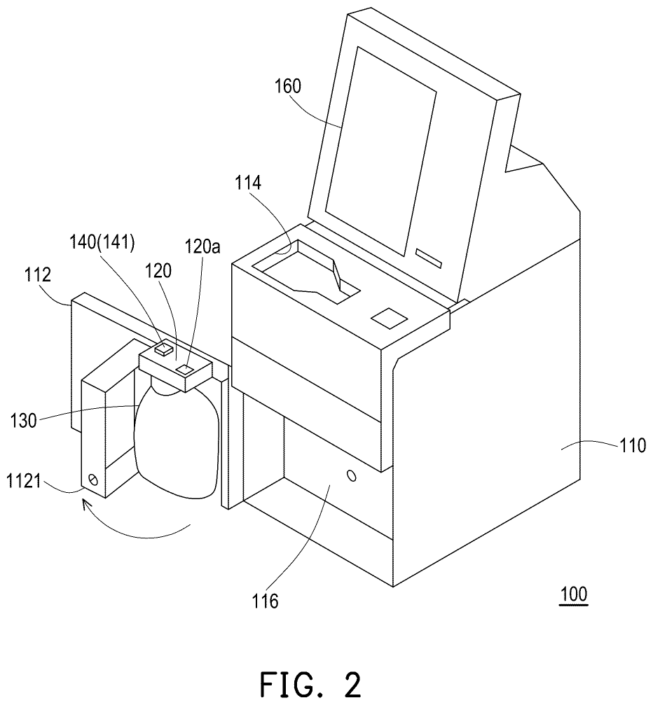

FIG. 1 is a perspective view of a deposit machine according to an embodiment of the disclosure. FIG. 2 is a perspective view illustrating a cover of the deposit machine of FIG. 1 being opened. Referring to FIG. 1 and FIG. 2, in the present embodiment, a deposit machine 100 includes a housing 110 and a mounting portion 120. The housing 110 has a door 112, the mounting portion 120 is disposed on an inner side of the door 112 and is configured to mount a storage container 130 for storing coins. The mounting portion 120 is exposed when the door 112 is opened as shown in FIG. 1, and the mounting portion 120 is hidden inside the housing 110 when the door 112 is closed. In addition, the door 112 has a cover 1121 configured to cover the storage container 130 mounted on the mounting portion 120 as shown in FIG. 1. The storage container 130 is exposed when the cover 1121 is opened as shown in FIG. 2. In a state that the door 112 is closed and the mounting portion 120 and the storage container 130 are located inside the housing 110, a user may deposit coins through a coin inlet 114 of the housing 110, and the coins enter the storage container 130 through an entrance 120a of the mounting portion 120.

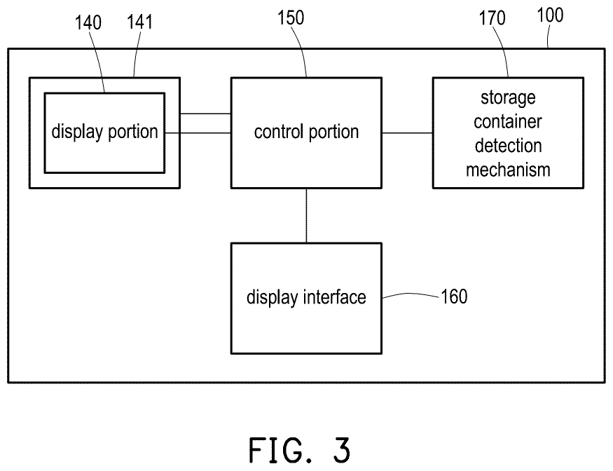

FIG. 3 is a schematic diagram of partial components of the deposit machine of FIG. 1. Referring to FIG. 1 and FIG. 3, the deposit machine 100 of the embodiment further includes a display portion 140, a reset button 141 and a control portion 150. The display portion 140 and the reset button 141 are coupled to the control portion 150 and are provided corresponding to the mounting portion 120. The display portion 140 may include an indicating light (e.g., an LED or other types of light emitting element) to clearly display by emitting light. The display portion 140 is disposed on the mounting portion 120, and the display portion 140 may be integrated with the reset button 141 to simplify the arrangement of the display portion 140 and the reset button 141. For example, the reset button 141 includes a transparent button and the display portion 140 is disposed inside or under the transparent button, and the disclosure is not limited thereto. The display portion 140 and the reset button 141 are exposed when the door 112 is opened as shown in FIG. 1, and the display portion 140 and the reset button 141 are hidden inside the housing 110 when the door 112 is closed. Accordingly, the display portion 140 and the reset button 141 may be hidden by the door 112 to be prevented from being operated accidentally. The control portion 150 is disposed inside the housing 110 and may include a control circuit, which is configured to control the display portion 140 according to statuses of the mounting portion 120 and/or the storage container 130.

Specifically, the storage container 130 does not need to be replaced when the number and/or total amount of coins deposited into the storage container 130 does not reach a predetermined value, and the control portion 150 controls the display portion 140 to be in a turn off state correspondingly. On the contrary, the storage container 130 needs to be replaced when the number and/or total amount of coins deposited into the storage container 130 reaches the predetermined value which means that the storage container 130 is full of coins or contains a preset number and/or total amount of coins, and the control portion 150 correspondingly controls the display portion 140 to turn on and display a first status (e.g., emitting light continuously) for reminding a user to replace the storage container 130. That is, the control portion 150 is configured to control the display portion 140 to display the first status in response to the storage container 130 mounted on the mounting portion 120 being to be a target for removal from the mounting portion 120.

After the storage container 130 is removed from the mounting portion 120 by the user for taking out the coins therein, the control portion 150 correspondingly controls the display portion 140 to display a second status (e.g., emitting light in a slow blinking manner) different from the first status for reminding the user to mount an empty storage container 130 on the mounting portion 120. That is, the control portion 150 is configured to control the display portion 140 to display the second status in response to the storage container 130 being removed from the mounting portion when the display portion 140 displays the first status. After an empty storage container 130 is mounted on the mounting portion 120 by the user, the control portion 150 correspondingly controls the display portion 140 to display a third status (e.g., emitting light in a quick blinking manner) different from the first status and the second status for reminding the user to reset an inventory of the storage container 130. Then, after the reset button 141 is pressed by the user, the control portion 150 correspondingly reset the inventory of the storage container 130 and controls the display portion 140 to turn off. That is, the display portion 140 is configured to be controlled by the control portion 150 to display the third status in response to the storage container 130 being mounted on the mounting portion 120 again, and the control portion 150 is configured to reset the inventory of the storage container 130 and turn off the display portion 140 in response to the reset button 141 being pressed after the storage container 130 mounted on the mounting portion 120 is removed from the mounting portion 120 and another storage container 130 is mounted on the mounting portion 120 again.

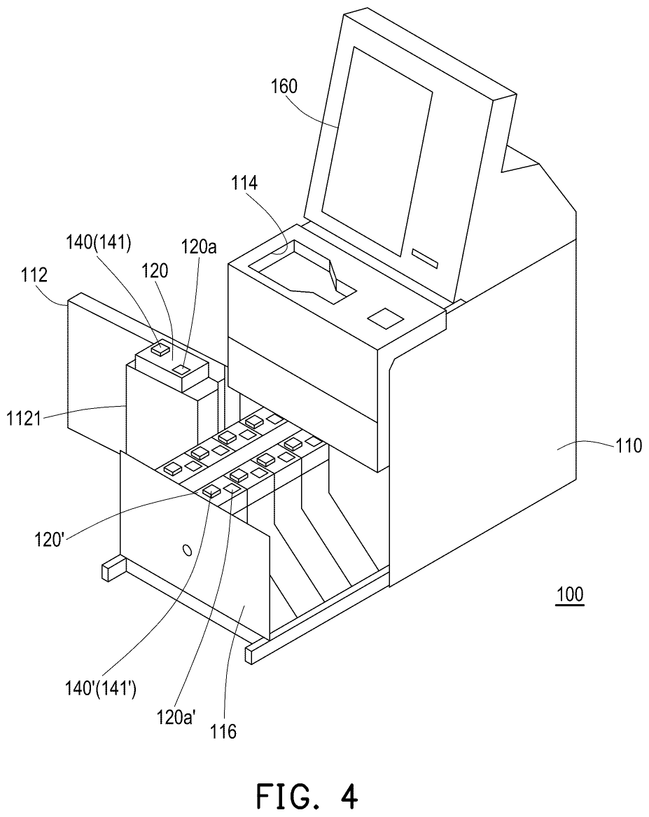

FIG. 4 is a perspective view illustrating a drawer portion of the deposit machine of FIG. 1 being slid out. Referring to FIG. 4, the housing 110 of the deposit machine 100 of the embodiment further has a drawer portion 116 for carrying a plurality of mounting portions 120′, a plurality of display portions 140′ and a plurality of reset buttons 141′. The mounting portions 120′, the display portions 140′ and the reset buttons 141′ are exposed when the drawer portion 116 is slid out as shown in FIG. 4. The arrangements and operations of the mounting portion 120′, the entrance 120a′, the display portion 140′ and the reset button 141′ are the same as or similar to that of the mounting portion 120, the entrance 120a, the display portion 140 and the reset button 141 and will not be described in detail again.

As described above, the deposit machine 100 of the embodiment reminds the user to remove the storage containers 130 from the mounting portion 120 and/or the mounting portions 120′, mount the empty storage containers 130 on the mounting portion 120 and/or the mounting portions 120′, and reset the inventory of the storage containers 130 respectively, by different display statuses of the display portions 140 and 140′ corresponding to the mounting portion 120 and/or the mounting portions 120′ mounting the storage container 130. Therefore, the deposit machine 100 of the embodiment may prevent the user from making mistakes when replacing and resetting the storage containers 130, so as to shorten the downtime of the deposit machine 100 when replacing and resetting the storage containers 130. In addition, based on the clear reminder of the display portions 140 and 140′ of this embodiment mentioned above, even beginners may replace and reset the storage containers 130 easily. Further, the user may reset the storage container 130 and turn off the display portion 140 at the same time easily by pressing the reset button 141.

The storage container 130 of the embodiment is, for example, a pouch made of vinyl or other types of resin material. In other embodiments, the storage container 130 may be a storage bin or other types of containers and the disclosure is not limited thereto. In addition, the disclosure does not limit the specific display manners of the first status, the second status and the third status of the display portion 140 or the display portion 140′. In other embodiments, the first status, the second status and the third status of the display portion 140 or the display portion 140′ may be other display manners respectively. For example, the first status, the second status and the third status of the display portion 140 or the display portion 140′ may be distinguished from each other by different colors of light.

In the present embodiment, coins of different denominations are stored in different storage containers, but the disclosure is not limited thereto. In other embodiments, each storage container can store coins of multiple denominations. In addition, the deposit machine 100 of the embodiment may have a function of recording the number and denomination and/or total amount of coins deposited into the storage container 130. This function is, for example, performed by a coin recognition/conveying system inside the housing 110 and controlled by the control portion 150.

The deposit machine 100 of the embodiment further includes a display interface 160 disposed outside the housing 110 and coupled to the control portion 150. The display interface 160 may include a display panel, such as an LCD panel or other types of display panel, and the disclosure is not limited thereto. In a condition that the reset button 141 or the reset button 141′ is not pressed by the user after the storage container 130 is mounted on the mounting portion 120 or the mounting portion 120′ again and an operation of the deposit machine 100 is resumed, the control portion 150 controls the display interface 160 to display a notification to notify the user that the reset button 141 or the reset button 141′ has not been pressed and the inventory of the storage container 130 will be accumulated from a previous amount. That is, the display interface 160 is configured to display the notification and the inventory of the storage container 130 is accumulated from the previous amount in response to the operation of the deposit machine 100 being resumed without pressing the reset button 141 or the reset button 141′ after the storage container 130 is mounted on the mounting portion 120 again. Accordingly, the user may clearly know whether the storage container 130 has been reset and/or be reminded again if the user forgot to press the reset button 141 or the reset button 141′. Moreover, even if a storage container 130 that does not need to be replaced is accidentally removed and reinstalled, the inventory thereof may be accumulated from the previous amount as long as the reset button 141 is not pressed.

The following describes how to determine whether the storage container is mounted on the mounting portion in the embodiment.

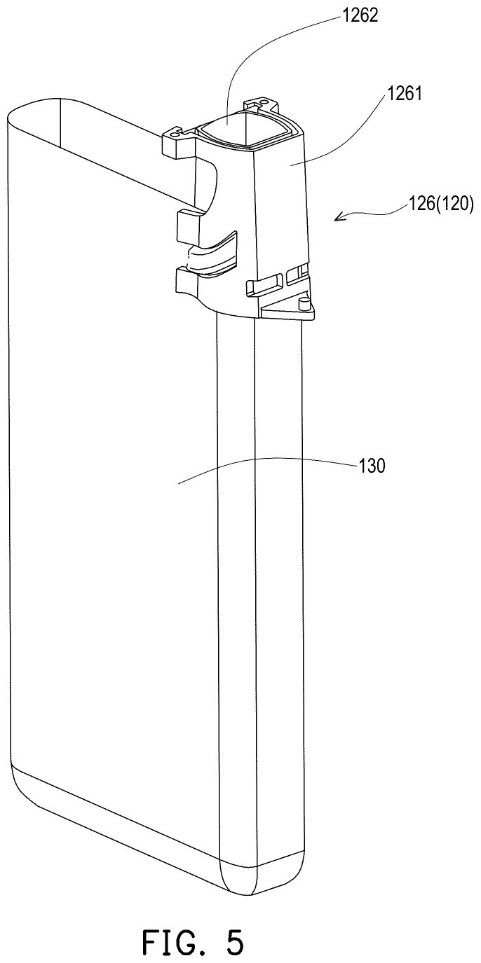

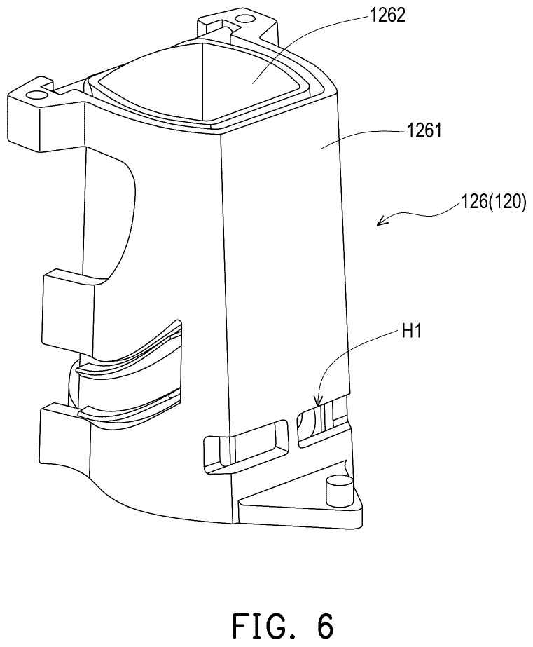

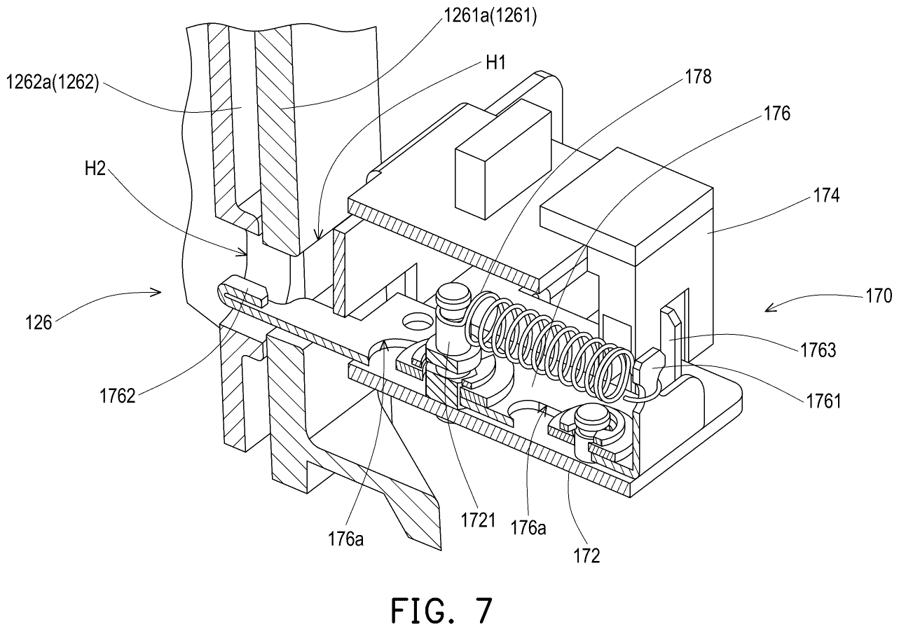

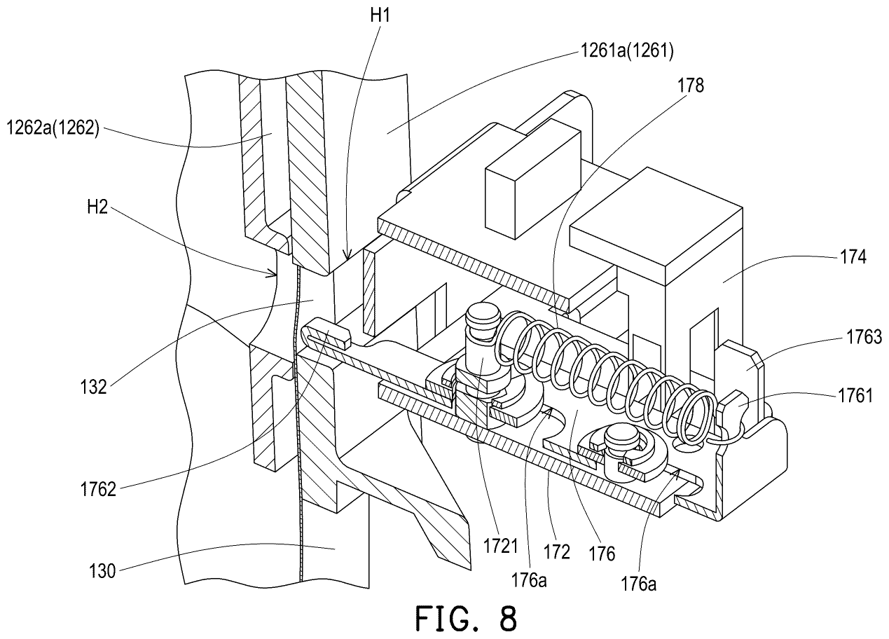

FIG. 5 is a perspective view illustrating partial structures of the mounting portion of FIG. 1 mounting a storage container. FIG. 6 is a perspective view illustrating the partial structures of the mounting portion of FIG. 5. FIG. 7 is a perspective view illustrating a storage container detection mechanism corresponding to the mounting portion of FIG. 5. FIG. 8 is a perspective view illustrating the pouch being clamped by the mounting portion of FIG. 7. Referring to FIG. 5 to FIG. 7, a mounting structure 126 of the mounting portion 120 of the embodiment includes a chute base 1261 and a coin chute 1262 disposed on the chute base 1261. The coins are adapted to be deposited into the pouch (the storage container 130) through the guiding of the coin chute 1262. A side wall 1261a of the chute base 1261 and a side wall 1262a of the coin chute 1262 form a clamp part. As shown in FIG. 8, the mounting structure 126 of the mounting portion 120 is configured to clamp the pouch (the storage container 130) by the clamp part. Specially, the mounting structure 126 of the mounting portion 120 is configured to clamp the pouch (the storage container 130) between the side wall 1261a of the chute base 1261 and the side wall 1262a of the coin chute 1262.

Referring to FIG. 7 and FIG. 8, the deposit machine 100 of the embodiment further includes a storage container detection mechanism 170 coupled to the control portion 150 (illustrated in FIG. 3). The side wall 1261a of the chute base 1261 has an opening H1, and the storage container detection mechanism 170 is adjacent to the side wall 1261a of the chute base 1261 and corresponding to the opening H1. The storage container detection mechanism 170 is configured to detect a taut part 132 of the pouch (the storage container 130) through the opening H1, as shown in FIG. 8.

In detail, the storage container detection mechanism 170 includes a main body 172, a detection portion 174, a movable portion 176 and an elastic component 178. The detection portion 174 is disposed on the main body 172, and the movable portion 176 is, for example, a plate-shaped component and is movably disposed on the main body 172. Specifically, the movable portion 176 may be slidably disposed on the main body 172 by its guiding slots 176a. The elastic component 178 is, for example, a spring and is connected between a pillar portion 1721 of the main body 172 and a bending end 1761 of the movable portion 176.

When the pouch (the storage container 130) is not clamped by the clamp part, a detection end 1762 of the movable portion 176 is configured to protrude through the opening H1 toward the mounting structure 126 of the mounting portion 120 and reach an opening H2 of the side wall 1262a of the coin chute 1262 by an elastic force of the elastic component 178 as shown in FIG. 7. When the pouch (the storage container 130) is clamped by the clamp part, the movable portion 176 is pushed backward from the mounting structure 126 of the mounting portion 120 by the pouch (the storage container 130) as shown in FIG. 8. The detection portion 174 is configured to detect whether the pouch (the storage container 130) is clamped by the clamp part according to a position of the movable portion 176 relative to the detection portion 174.

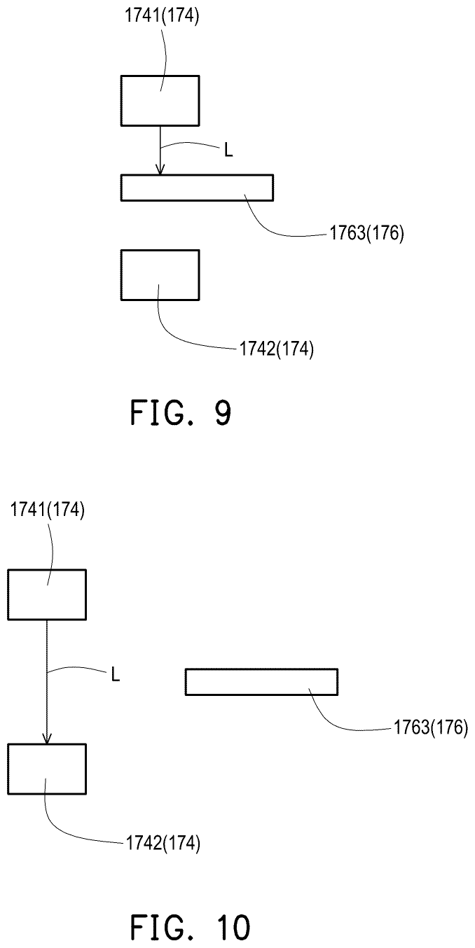

FIG. 9 and FIG. 10 are schematic diagrams illustrating an operation manner of the detection portion in FIG. 7 and FIG. 8. Referring to FIG. 9 and FIG. 10, specifically, the detection portion 174 of the embodiment is an optical detection device, which includes a light emitting element 1741 and a light sensing element 1742. The light emitting element 1741 is, for example, a LED or a laser diode, and the light sensing element 1742 is a light receiver corresponding to the light emitting element 1741. When the movable portion 176 protrudes through the opening H1 toward the mounting structure 126 of the mounting portion 120 as shown in FIG. 7, a block end 1763 of the movable portion 176 blocks between the light emitting element 1741 and the light sensing element 1742 as shown in FIG. 9, and a light L emitted from the light emitting element 1741 is blocked by the block end 1763 and does not reach the light sensing element 1742. When the movable portion 176 is pushed backward from the mounting structure 126 of the mounting portion 120 by the pouch (the storage container 130) as shown in FIG. 8, the block end 1763 of the movable portion 176 is away from between the light emitting element 1741 and the light sensing element 1742 as shown in FIG. 10, and the light L emitted from the light emitting element 1741 is not blocked by the block end 1763 and reaches the light sensing element 1742. Therefore, the optical detection device 174 may determine the position of the movable portion 176 based on whether the light sensing element 1742 receives the light L, and then determine whether the pouch (the storage container 130) is mounted on the mounting portion 120.

As described above, the pouch (the storage container 130) is detected when it is clamped by the clamp portion to formed the taut part 132, and the taut part 132 is able to be maintained in a flat state by its tension, such that a situation that the pouch (the storage container 130) is unable to be detected successfully due to the irregular shape of the soft pouch (the storage container 130) may be avoided. Further, according to the arrangement of the clamp part, the pouch (the storage container 130) may be firmly clamped by the chute base 1261 and the coin chute 1262 to reliably form the taut part 132. In addition, according to the arrangement of the movable portion 176 and the detection portion 174, the storage container detection mechanism 170 may accurately detect whether the pouch (the storage container 130) is mounted on the mounting portion 120 based on the position of the movable portion by the light emitting element 1741 and the light sensing element 1742. Moreover, according to the arrangement of the elastic component 178, the movable portion 176 may restore automatically by the elastic force of the elastic component 178.

In some embodiments, since the coin transfer frequency of a coin chute corresponding to small denomination coins is usually large, in order to prevent the coin chutes 1262 of some of the mounting portions 120 from being severely worn due to a large number of coins being transferred, the control portion 150 may be set to record the total number of transferred coins corresponding to each pouch and periodically control the display interface 160 to display a reminder message to remind the user that the denomination of the coin corresponding to the storage containers 130 may be switched. The user may decide whether to switch the denomination of the coin corresponding to the storage containers 130 according to the reminder message. The recording and switching operation may be performed by a coin recognition/conveying system inside the housing 110 and controlled by the control portion 150. Specifically, if the denomination corresponding to one of the pouches is smaller than that corresponding to at least another one of the pouches, then the denomination corresponding to the one of the pouches may be changed to be larger than that corresponding to the another one of the pouches after a period of time. The following is an example of this through Table A1 to Table A3.

TABLE A1

| | 1^{st} | 2^{nd} | 3^{rd} | 4^{th} | 5^{th} | 6^{th} | 7^{th} | 8^{th} |
|---|---|---|---|---|---|---|---|---|
| | Pouch | Pouch | Pouch | Pouch | Pouch | Pouch | Pouch | Pouch |
| Denomination | 1 cent | 2 cent | 5 cent | 10 cent | 20 cent | 50 cent | 1 EUR | 2 EUR |
| Total number | 8000 | 7000 | 6000 | 5000 | 4000 | 3000 | 2000 | 1000 |
| of transferred | | | | | | | | |
| coins | | | | | | | | |

TABLE A2

| | 1^{st} | 2^{nd} | 3^{rd} | 4^{th} | 5^{th} | 6^{th} | 7^{th} | 8^{th} |
|---|---|---|---|---|---|---|---|---|
| | Pouch | Pouch | Pouch | Pouch | Pouch | Pouch | Pouch | Pouch |
| Denomination | 2 EUR | 1 EUR | 50 cent | 20 cent | 10 cent | 5 cent | 2 cent | 1 cent |
| Total number | 8000 | 7000 | 6000 | 5000 | 4000 | 3000 | 2000 | 1000 |
| of transferred | | | | | | | | |
| coins | | | | | | | | |

TABLE A3

| | 1^{st} | 2^{nd} | 3^{rd} | 4^{th} | 5^{th} | 6^{th} | 7^{th} | 8^{th} |
|---|---|---|---|---|---|---|---|---|
| | Pouch | Pouch | Pouch | Pouch | Pouch | Pouch | Pouch | Pouch |
| Denomination | 2 EUR | 1 EUR | 50 cent | 20 cent | 10 cent | 5 cent | 2 cent | 1 cent |
| Total number | 9000 | 9000 | 9000 | 9000 | 9000 | 9000 | 9000 | 9000 |
| of transferred | | | | | | | | |
| coins | | | | | | | | |

The initial setting is shown in Table A1. Taking the first pouch as an example, the denomination corresponding to the first pouch in the setting of Table A1 is 1 cent, and thus the total number of transferred coins of the first pouch (shown as 8000 in Table A1) during a period of time is large than that of other pouches. In view of this, the initial setting may be changed to a different setting shown in Table A2. In the setting of Table A2, the denomination corresponding to the first pouch is 2 EUR, and thus the total number of transferred coins (shown as 9000 in Table A3) of the first pouch during a further period of time is the same as that of other pouches as shown in Table A3.

In some embodiments, the user may actively switch the denomination of the coin corresponding to the mounting portions 120 without being reminded by the reminder message. In some embodiments, the records of the number of transferred coins corresponding to each pouch may be taken as a reference for studying the circulation of denominations. In some embodiments, in a condition that the records of the total number of transferred coins exceeds a certain number, the deposit machine 100 may remind the user to check the wear of the coin chutes. In some embodiments, in a condition that the records of the total number of transferred coins exceeds a certain number, the deposit machine 100 may detect whether the coin chutes have deteriorated with stricter standards.

Alternatively, for the same purpose (preventing the coin chutes of some of the mounting portions from being severely worn due to a large number of coins being transferred), in some embodiments, coins of various denominations may be deposited into the same storage container, the control portion may be set to record the total number of transferred coins corresponding to each storage container (e.g., each bin), and the priority of the storage containers is determined and switched based on the total number of transferred coins corresponding to each storage container. The recording and switching operation may be performed by a coin recognition/conveying system inside the housing and controlled by the control portion, and the coin recognition/conveying system is a known technology in the technical field and will not be described in detail here. Specifically, if the storage ratio of the first priority storage container exceeds a predetermined ratio and the total number of transferred coins corresponding to the first priority storage container is larger than that corresponding to another one of the storage containers, then the another one of the storage containers is changed to be a first priority storage container. The following is an example of this through Table B1 to Table B7.

TABLE B1

| | 1^{st} Bin | 2^{nd} Bin |
|---|---|---|
| Priority | First priority | Second priority |
| Storage ratio | 0% | 0% |
| Total number of transferred | 0 | 0 |
| coins | | |

TABLE B2

| | 1^{st} Bin | 2^{nd} Bin |
|---|---|---|
| Priority | First priority | Second priority |
| Storage ratio | 50% | 0% |
| Total number of transferred | 10000 | 0 |
| coins | | |

TABLE B3

| | 1^{st} Bin | 2^{nd} Bin |
|---|---|---|
| Priority | First priority | Second priority |
| Storage ratio | 0% | 0% |
| Total number of transferred | 10000 | 0 |
| coins | | |

TABLE B4

| | 1^{st} Bin | 2^{nd} Bin |
|---|---|---|
| Priority | Second priority | First priority |
| Storage ratio | 0% | 0% |
| Total number of transferred | 10000 | 0 |

coins

TABLE B5

| | 1^{st} Bin | 2^{nd} Bin |
|---|---|---|
| Priority | Second priority | First priority |
| Storage ratio | 0% | 25% |
| Total number of transferred | 10000 | 5000 |
| coins | | |

TABLE B6

| | 1^{st} Bin | 2^{nd} Bin |
|---|---|---|
| Priority | Second priority | First priority |
| Storage ratio | 0% | 0% |
| Total number of transferred | 10000 | 5000 |
| coins | | |

TABLE B7

| | 1^{st} Bin | 2^{nd} Bin |
|---|---|---|
| Priority | Second priority | First priority |
| Storage ratio | 0% | 10% |
| Total number of transferred | 10000 | 7000 |
| coins | | |

The initial setting is shown in Table B1, in which the first bin (one of the storage containers) is the first priority storage container. When the storage ratio of the first priority storage container (the first bin) exceeds a predetermined ratio (50%) as shown in Table B2, the first bin is replaced such that the storage ratio thereof becomes 0% as shown in Table B3. Since the total number of transferred coins (10000) of the first bin is larger than that (0) of the second bin at this time, the second bin is changed to be a first priority storage container as shown in Table B4. Then, when the storage ratio of the first priority storage container (the second bin) exceeds a predetermined ratio (25%) as shown in Table B5, the second bin is replaced such that the storage ratio thereof becomes 0% as shown in Table B6. Since the total number of transferred coins (5000) of the second bin is smaller than that (10000) of the first bin at this time, the second bin is still a first priority storage container and its storage ratio and total number of transferred coins continue to increase as shown in Table B7. According to the priority switching manner mentioned above, the risk of two bins being full at the same time is reduced.

The priority switching manner mentioned above uses the total number of transferred coins as the criterion for judging deterioration of the coin transferring path (e.g., the coin chute). However, the present disclosure is not limited thereto. In other embodiments, the number of times the parts relevant to the coin transferring path have been replaced, the time elapsed since the parts were replaced, or the number of errors that have occurred when transferring coins may be used as the criterion for judging the deterioration. Specifically, in a condition that the relevant parts of a certain transferring path are replaced less often, it can be inferred that the transferring path is less degraded, so this transferring path may be prioritized for transferring. Similarly, in a condition that the time elapsed since the parts were replaced is short, it can be inferred that the transferring path is less degraded, so this transferring path may be prioritized for transferring. Similarly, in a condition that the number of errors that have occurred when transferring coins is small, it can be inferred that the transferring path is less degraded, so this transferring path may be prioritized for transferring.

In some embodiments, in a condition that the records of the total number of transferred coins exceeds a certain number, the deposit machine may remind the user to check the wear of the coin chutes. In some embodiments, in a condition that the records of the total number of transferred coins exceeds a certain number, the deposit machine may detect whether the coin chutes have deteriorated with stricter standards.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A deposit machine, comprising:
a mounting portion configured to mount a storage container to store coins;
a display portion corresponding to the mounting portion; and
a control portion configured to control the display portion to display a first status in response to the storage container mounted on the mounting portion being to be a target for removal from the mounting portion,
the control portion is configured to control the display portion to display a second status different from the first status in response to the storage container being removed from the mounting portion when the display portion displays the first status.

2. The deposit machine according to claim 1, wherein the display portion comprises an indicating light.

3. The deposit machine according to claim 1, wherein the control portion is configured to control the display portion to display a third status different from the second status in response to a storage container being mounted on the mounting portion again.

4. The deposit machine according to claim 1, comprising a reset button corresponding to the mounting portion.

5. The deposit machine according to claim 4, wherein the reset button is configured to turn off the display portion when pressed after a storage container is mounted on the mounting portion again.

6. The deposit machine according to claim 4, wherein the reset button is configured to reset an inventory of the storage container when pressed after a storage container is mounted on the mounting portion again.

7. The deposit machine according to claim 4, wherein the display portion is integrated with the reset button.

8. The deposit machine according to claim 4, comprising a housing having a door, wherein
the display portion and the reset button are disposed in the housing, and exposed when the door is opened.

9. The deposit machine according to claim 4, comprising
a display interface disposed outside the housing, wherein
the display interface is configured to display a notification in response to an operation of the deposit machine being resumed without pressing the reset button after the storage container is mounted on the mounting portion again.

10. The deposit machine according to claim 6, wherein an inventory of the storage container is accumulated from a previous amount in response to an operation of the deposit machine being resumed without pressing the reset button after the storage container is mounted on the mounting portion again.

11. The deposit machine according to claim 1, comprising a storage container detection mechanism, wherein
the mounting portion has a clamp part configured to clamp the storage container, the clamp part has an opening, and
the storage container detection mechanism is configured to detect a taut part of the storage container through the opening.

12. The deposit machine according to claim 11, wherein the mounting portion comprises a chute base and a coin chute disposed on the chute base,
a side wall of the chute base and a side wall of the coin chute form the clamp part,
the mounting portion is configured to clamp the storage container between the side wall of the chute base and the side wall of the coin chute, the opening is formed on the side wall of the chute base, and
the storage container detection mechanism is adjacent to the side wall of the chute base and corresponding to the opening.

13. The deposit machine according to claim 11, wherein the storage container detection mechanism comprises a main body, a detection portion and a movable portion,
the detection portion is disposed on the main body,
the movable portion is movably disposed on the main body,
the movable portion protrudes through the opening toward the mounting portion when the storage container is not clamped by the clamp part,
the movable portion is pushed backward from the mounting portion by the storage container when the storage container is clamped by the clamp part, and
the detection portion is configured to detect whether the storage container is clamped by the clamp part according to a position of the movable portion relative to the detection portion.

14. The deposit machine according to claim 13, wherein the detection portion comprises an optical detection device.

15. The deposit machine according to claim 14, wherein the optical detection device comprises a light emitting element and a light sensing element,
the movable portion blocks between the light emitting element and the light sensing element when the movable portion protrudes through the opening toward the mounting portion, and
the movable portion is away from between the light emitting element and the light sensing element when the movable portion is pushed backward from the mounting portion.

16. The deposit machine according to claim 13, wherein the storage container detection mechanism comprises an elastic component,
the elastic component is connected between the main body and the movable portion,
the movable portion is configured to protrude through the opening toward the mounting portion by an elastic force of the elastic component, and
the movable portion is configured to resist the elastic force of the elastic component to be pushed backward from the mounting portion.

17. A deposit machine, comprising:
a mounting portion configured to mount a storage container to store coins;
a display portion corresponding to the mounting portion;
a reset button corresponding to the mounting portion; and
a control portion configured to control the display portion to display in response to the storage container mounted on the mounting portion being a target for removal from the mounting portion, and reset an inventory of the storage container in response to the reset button being pressed after the storage container mounted on the mounting portion is removed from the mounting portion and a storage container is mounted on the mounting portion again.

18. The deposit machine according to claim 17, wherein the display portion comprises an indicating light.

19. The deposit machine according to claim 17, wherein the display portion is integrated with the reset button.

20. The deposit machine according to claim 17, comprising a plurality of the mounting portions, a plurality of the display portions corresponding to the mounting portions respectively and a plurality of the reset buttons corresponding to the mounting portions respectively.
